(19) United States
(12) Patent Application Publication
(10) Pub. No.: US 2020/0110286 A1
(43) Pub. Date: Apr. 9, 2020

(54) SYSTEMS AND METHODS FOR SHORTENED CORRIDOR PROGRESSIVE LENSES WITH SUPERIOR DISTANCE VISION AREA

(71) Applicant: FGX International Inc., Smithfield, RI (US)

(72) Inventors: Eric Rhea, Cumberland, RI (US); Patrick McCollum, Craigavon (GB); Richard McRoberts, Belfast (GB)

(21) Appl. No.: 16/593,009

(22) Filed: Oct. 4, 2019

Related U.S. Application Data
(60) Provisional application No. 62/855,471, filed on May 31, 2019.
(60) Provisional application No. 62/741,220, filed on Oct. 4, 2018.

(51) Int. Cl. G02C 7/06

(52) U.S. Cl. CPC G02C 7/066

(57) ABSTRACT

The inventive lens includes a large distance vision area located at, and above, a wearer's natural “straight-ahead” gaze, a full power near vision area for, e.g., reading, and other activities, while accommodating a comfortable intermediate vision zone for transition magnification powers. One aspect of the inventive lens provides a shortened corridor design for a given fit point and reference point.

### CLAIM OF PRIORITY

The present non-provisional patent application claims priority pursuant to 35 US.C. § 119(e) to currently pending and prior filed provisional patent application having U.S. Ser. No. 62/741,220, filed on Oct. 4, 2018, as well as to currently pending and prior filed provisional patent application having U.S. Ser. No. 62/855,471, filed on May 31, 2019, the contents of which are both explicitly incorporated herein, by reference, in their entireties.

### BACKGROUND OF THE INVENTION

### Field of the Invention

The present invention relates to a progressive lenses and associated systems and methods.

### Description of the Related Art

A progressive addition lens may be generally described as an ophthalmic lens including multiple areas with different powers of magnification, and which transitions “progressively” between these areas, in contrast to, e.g., a bifocal lens which includes two distinct magnification powers delineated by a sharp boundary. Typical progressive lenses can include a distance vision area, an intermediate vision area, and a near vision area, with various powers of magnification to assist with distance vision, intermediate vision, and near vision. The distance vision area may have no magnification (a “plano” lens region) or it may include a base distance prescription suitable for the wearer. The near vision area includes a maximum addition (or “add”) power of magnification suitable for the wearer. The intermediate vision area is generally a progressive gradient that transitions from the distance vision area to the near vision area.

Many difficulties can arise in attempting to accommodate the spatial requirements for all three areas on a single lens. Different use cases may dictate that certain parameters are primary. By way of non-limiting example, those who work in an office may prefer a larger near vision area for reading documents, while those who work outside may prefer a larger distance area. Comfort of the wearer must be accounted for as well. The mixture of cylindrical and spherical lens profiles necessary to shape the three vision zones also cause astigmatic regions throughout the lens, which are usually placed on the periphery of the lens as a matter of design intent. However, one must be careful when designing and fitting a lens to avoid requiring the wearer to look through an astigmatic region as the eye traverses through the three zones. Generally, even despite advancements in lens technologies, there is a need in the art for a truly “all-purpose” or “all-day” progressive addition lens, as current offerings do not easily transition from various use cases, e.g., from reading the morning paper, to walking, and then to reading from a computer monitor. Some ophthalmic patients have taken to purchasing multiple prescriptions (e.g., reading glasses, computer glasses) or perhaps wear a set of a contact lenses suitable for distance vision, and supplement with reading glasses as necessary.

These shortcomings are compounded by modern eyewear style trends dictating the use of smaller lenses (e.g., within the range of approximately 40 mm tall by 60 mm wide, or smaller). One attempt at addressing this problem is disclosed in U.S. Pat. No. 6,142,627 to Winthrop. Therein, a progressive ophthalmic lens designed for use in eyeglass frames having a lens height or vertical dimension (generally referred to as the “B” dimension in the eyewear industry) of less than 36 mm is disclosed. The lens design features a short (nominally 13-14.5 mm) progressive corridor. Winthrop indicates that distortion (astigmatism) would be increased from simply compressing a larger optical design into a smaller area, and Winthrop attempts to compensate by permitting the astigmatic aberration to extend into the peripheral zones of the distance portion above the distance fitting center. The result is that the wearer must look higher through the lens in order to find a comfortable distance vision area that does not include astigmatic aberration in the wearer's peripheral vision.

The inventive lens disclosed herein simultaneously provides a complete and full power magnification near vision area for activities such as reading, while accommodating a comfortable corridor length along the intermediate vision area, and also providing a distance vision area that does not require the wearer to strain his or her eyes by looking upward through the upper portion of the lens. Accordingly, a wearer that requires corrective lenses for near vision activities, such as reading glasses, and who utilizes the inventive lenses, does not have to remove or replace eyeglasses as the wearer transitions from near vision sight to distance vision sight and furthermore, when fit properly, the wearer may look comfortably straight ahead through the inventive lenses for distance vision.

### SUMMARY OF THE INVENTION

The inventors have determined that a desirable trait for a truly “all-purpose” or “all-day” lens is an enhanced distance vision area that does not significantly compromise the functionality of the intermediate and near vision areas. Whereas some progressive lenses situate the fit point of the lens within a “valley” of astigmatic aberration, providing the wearer with a relatively narrow band of usable lens within the distance vision area, one principal of the inventive lens places the fit point relatively higher on the lens design, and maintains relatively clear (free from significant astigmatic aberrations) peripheral regions within the distance vision zone.

However, with modern frame styles dictating relatively short lens heights, merely moving the fit point higher on the lens can result in a near vision zone which is too small to function adequately. Accordingly, the inventors have determined that a suitable compromise can be made by utilizing a shorter corridor length (intermediate vision area) than would otherwise be called for with respect to a given lens height. By way of non-limiting example, if a corridor length (intermediate vision area) of 14 mm is desired according to one embodiment of the present invention, then the inventive lens may be initially designed as if it were to have a 10 mm corridor length (intermediate vision area), but the fit point is adjusted 4 mm upward (toward the distance vision area) in order to provide a total of 14 mm between the fit point area and the reading reference point, but also allow a full size near vision area. The resulting compromise is that the corridor (intermediate vision area) has a narrower band of low cylinder than would otherwise be present had the design parameters dictated a standard 14 mm corridor.

Additionally, the inventors have determined that shifting the corridor nasally provides a significant benefit as well. It is desirable, generally, to position the topographic features of the lens design such that, as the wearer's eyes track through the intermediate vision area into the near vision area, the wearer is not required to look through higher levels of cylinder (astigmatic aberration) than is strictly necessary. Using the previous example of an inventive lens with a 14 mm corridor length, based on adjusting the fit point of a designed 10 mm corridor, the astigmatic aberration on the nasal side of the intermediate vision area begins to encroach on the wearer's field of view. This is because the wearer's eyes tend to track inward as the wearer focuses on near objects, and the wearer's gaze will shift downward as the wearer adjusts the position of the lens to find the appropriate magnification for a near object. Accordingly, shifting the corridor nasally provides the wearer with a suitable meridian that passes through the lowest amount of astigmatism. Again using the previous example, the inventors have found that a 0.25 mm shift in the nasal direction is suitable.

These and other objects, features, and advantages of the present invention will become clearer when the drawings, as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1A is a cylinder plot of a progressive lens having 1.00 maximum addition power in accordance with one embodiment of the present invention.

FIG. 1B is a mean power plot of a progressive lens having 1.00 maximum addition power in accordance with one embodiment of the present invention.

FIG. 2A is a cylinder plot of a progressive lens having 1.25 maximum addition power in accordance with one embodiment of the present invention.

FIG. 2B is a mean power plot of a progressive lens having 1.25 maximum addition power in accordance with one embodiment of the present invention.

FIG. 3A is a cylinder plot of a progressive lens having 1.50 maximum addition power in accordance with one embodiment of the present invention.

FIG. 3B is a mean power plot of a progressive lens having 1.50 maximum addition power in accordance with one embodiment of the present invention.

FIG. 4A is a cylinder plot of a progressive lens having 1.75 maximum addition power in accordance with one embodiment of the present invention.

FIG. 4B is a mean power plot of a progressive lens having 1.75 maximum addition power in accordance with one embodiment of the present invention.

FIG. 5A is a cylinder plot of a progressive lens having 2.00 maximum addition power in accordance with one embodiment of the present invention.

FIG. 5B is a mean power plot of a progressive lens having 2.00 maximum addition power in accordance with one embodiment of the present invention.

FIG. 6A is a cylinder plot of a progressive lens having 2.25 maximum addition power in accordance with one embodiment of the present invention.

FIG. 6B is a mean power plot of a progressive lens having 2.25 maximum addition power in accordance with one embodiment of the present invention.

FIG. 7A is a cylinder plot of a progressive lens having 2.50 maximum addition power in accordance with one embodiment of the present invention.

FIG. 7B is a mean power plot of a progressive lens having 2.50 maximum addition power in accordance with one embodiment of the present invention.

FIG. 8A is a cylinder plot of a progressive lens having 2.75 maximum addition power in accordance with one embodiment of the present invention.

FIG. 8B is a mean power plot of a progressive lens having 2.75 maximum addition power in accordance with one embodiment of the present invention.

FIG. 9A is a cylinder plot of a progressive lens having 3.00 maximum addition power in accordance with one embodiment of the present invention.

FIG. 9B is a mean power plot of a progressive lens having 3.00 maximum addition power in accordance with one embodiment of the present invention.

FIG. 10 is a schematic depiction of a pair of left and right lenses according to one embodiment of the present invention with various reference points noted thereon.

FIG. 11 is a schematic depiction of a preferred placement of lenses within eyewear frames according to one embodiment of the present invention.

FIG. 12 is a schematic depiction of a preferred placement of lenses within eye wear frames according to another embodiment of the present invention.

Like reference numerals refer to like parts throughout the several views of the drawings and all distances are indicated in millimeters.

### DETAILED DESCRIPTION OF THE PREFERRED EMBODIMENT

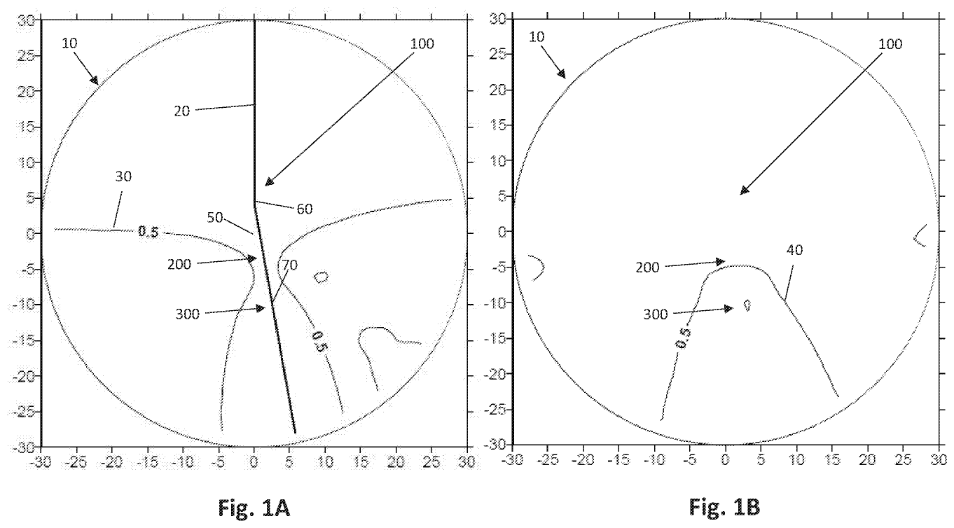

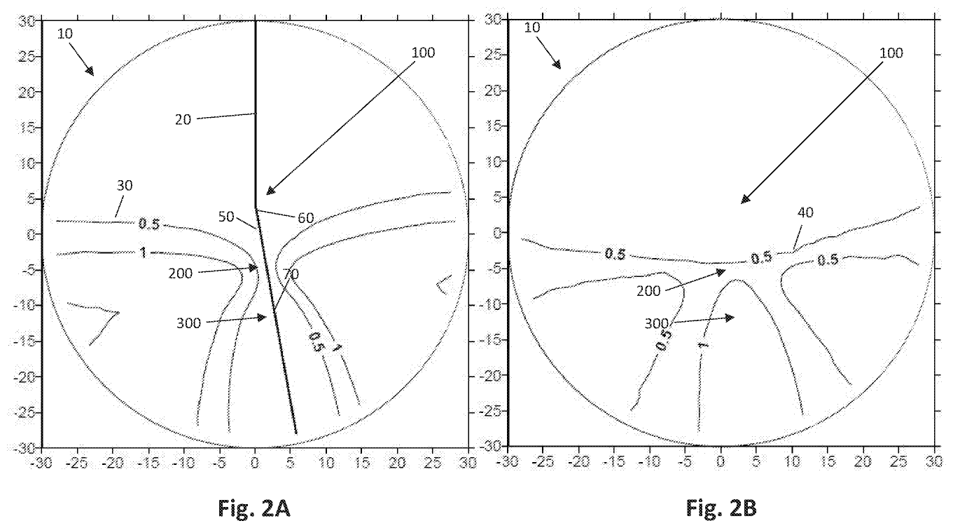

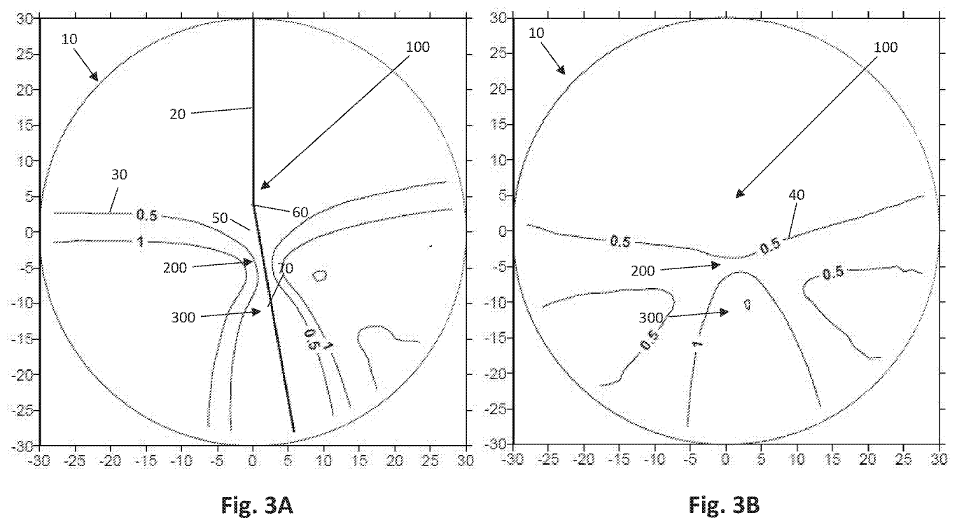

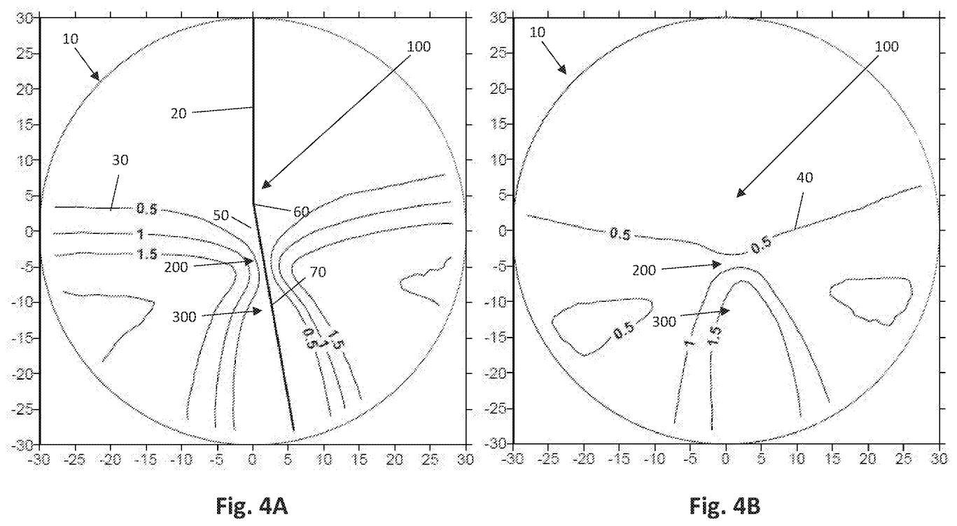

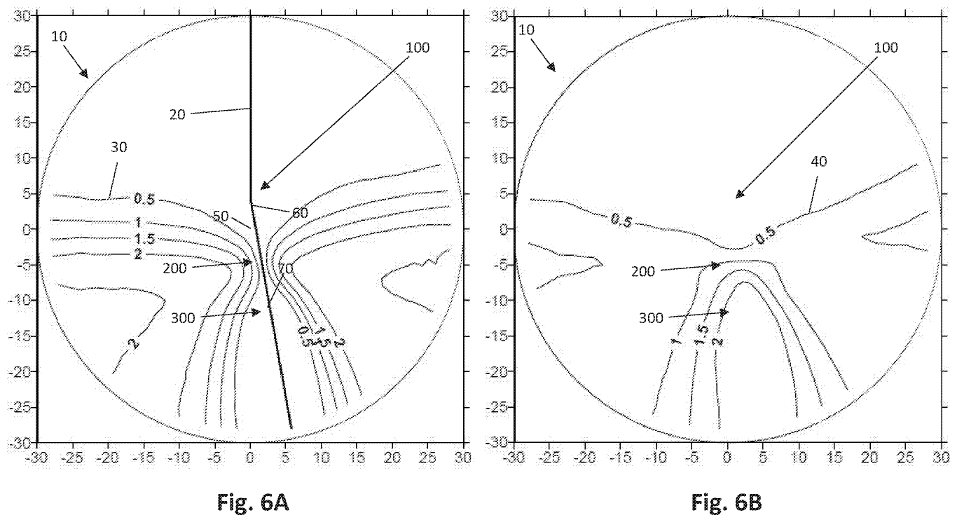

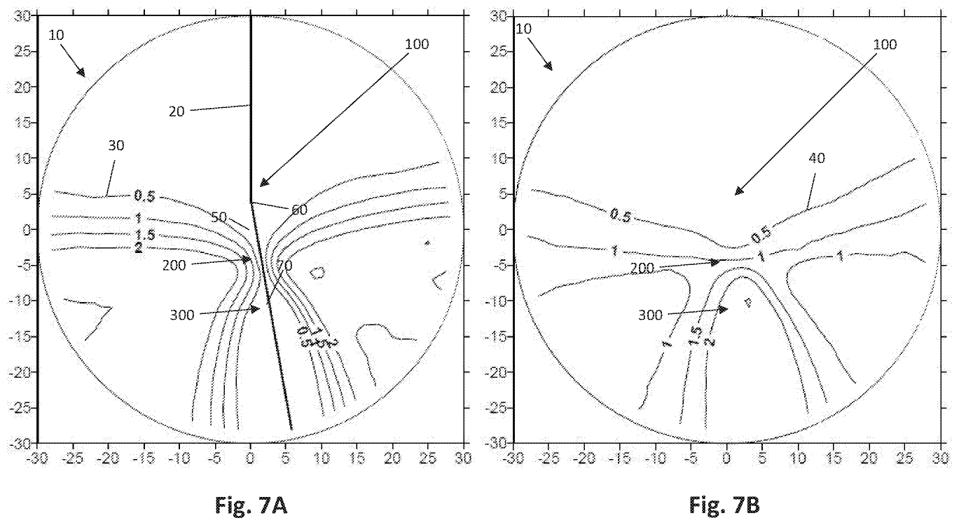

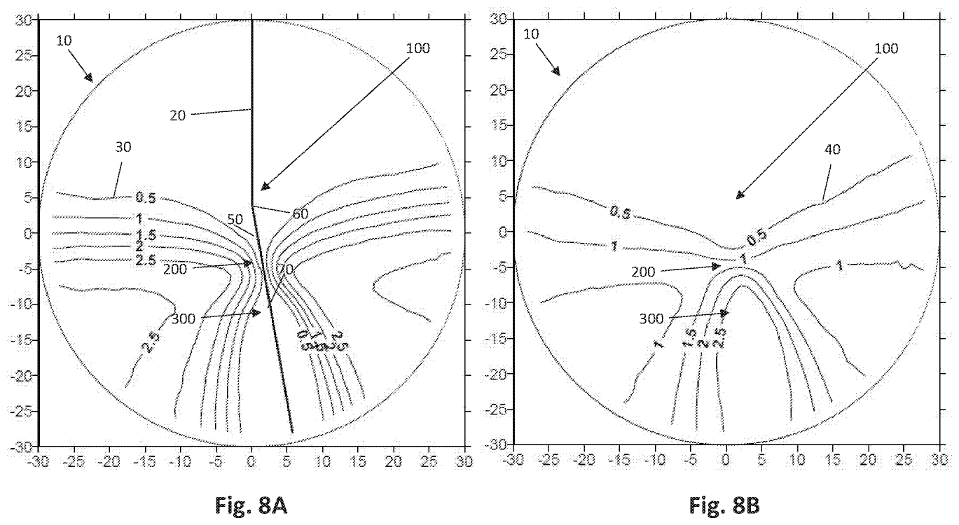

With reference to FIGS. 1A through 9B, depicted therein are various plots showing isocurves of various progressive lenses 10 according to several embodiments of the present invention, particularly progressive addition lenses 10 having maximum add powers ranging from 1.00 to 3.00. FIGS. 1A, 2A, 3A, 4A, 5A, 6A, 7A, 8A, and 9A are cylinder plots, with astigmatism isocurves 30 depicting the various levels of astigmatism throughout the lenses 10. FIGS. 1B, 2B, 3B, 4B, 5B, 6B, 7B, 8B, and 9B are mean power plots for the corresponding lenses 10, with magnification isocurves 40 depicting the various levels of magnification, or addition power, throughout the lens 10.

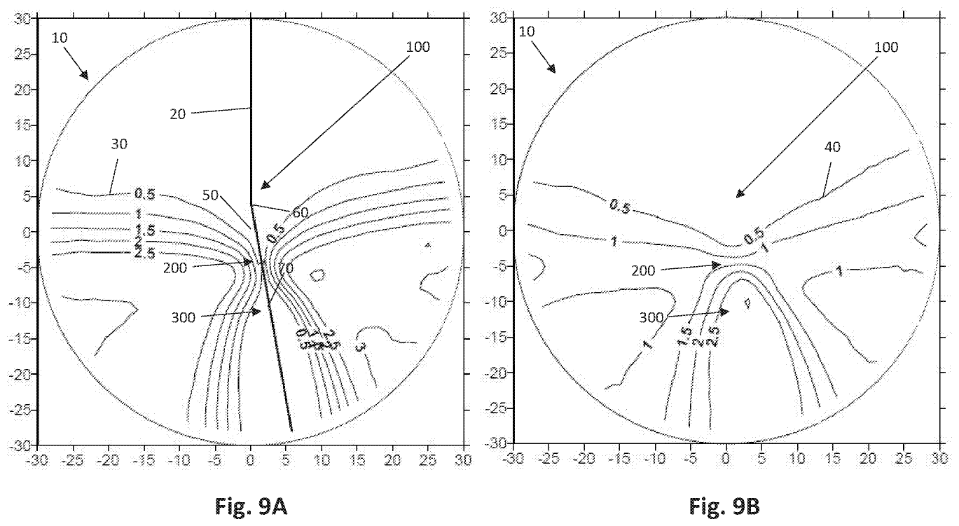

With continuing, general reference to FIGS. 1A through 9B, the various embodiments of the inventive lens 10 described and disclosed herein is a progressive lens 10 that, in at least one preferred embodiment, is intended to be fit on a wearer at 4 mm above the prism reference point (“PRP”) 50. With respect to the plots of FIGS. 1A through 9B, the fit point 60 is located at “0” along the horizontal axis and “+4” along the vertical axis (to be henceforth notated as (0, +4)). As such, when the wearer is appropriately fitted with the inventive lenses 10, the wearer's natural “straight-ahead” gaze will intersect with (0, +4). As can be seen in the mean power plot of FIG. 1B, this correlates to a comfortable margin within the lowest power of magnification. Even in embodiments having a maximum addition power of 3.00, as is depicted in FIG. 9B, where the progressive magnification gradient is relatively steep, the fit point 60 still provides the wearer with a comfortable margin of view within the lowest power of magnification. In a preferred embodiment the distance vision area 100 has an actual magnification power of zero (0), but may also be a base distance prescription based on the wearer's requirement. In either embodiment, the distance vision area 100 is considered to have zero (0) addition power. The near vision area 300 may have a predetermined “full” magnification power, and various embodiments of the inventive lens 10 may have varying full magnification powers in the near vision area 300 to provide various levels of magnification for various wearers.

As can also be seen in FIGS. 1A through 9B the distance vision area 100 is generally located from 4 mm above the PRP 50 and upwards, the near vision area 300 is located from 10 mm below the PRP 50 and downwards, while the intermediate vision area 200 is the area between the distance 100 and near vision areas 200, approximately 14 mm in length.

The corridor length of a progressive lens 10 is the distance through which the power of magnification transitions from the distance vision area 100 to the near vision area 300. As can be seen in FIGS. 1A through 9B, the corridor length of the depicted embodiments are each approximately 14 mm, extending from +4 mm above the PRP 50 to −10 mm below the PRP 50. As can also be seen with reference to the various cylinder plots, a median line 20 is depicted, representing the intended path of a wearer's vision as the wearer gazes up and down the lens. The median line 20 is more or less vertical throughout the distance vision area 100, and is angled toward the nasal side of the lens as it runs through the corridor and into the near vision area 300, which begins at approximately (2.5, −10).

Notably, in a preferred embodiment, the inventive lens 10 is intended to be advantageously arranged and fit upon a wearer such that the depicted median line 20 (and thus the wearer's line of sight through the lens) runs through the lowest amount of cylinder possible, while still providing a large distance vision area 100 at and above the PRP 50, a comfortable intermediate vision area 200, and an area of full power magnification at the near vision area 300.

One of the inventive principles which provides a superior distance vision area 100 relies on the fit point 60 of the lens 10 being placed within a relatively comfortable margin of view within the distance vision area 100, such that the wearer's “natural” straight ahead gaze does not impinge upon any significant amount of addition power or astigmatism. In the context of the various preferred embodiments disclosed herein, this margin, at its largest distance, can comprise the fit point 60 being positioned at about 9 mm above the 0.5 magnification isocurve 40 for a lens 10 having a maximum addition power of 1.00. The preferred shortest distance of this margin can comprise the fit point 60 being positioned at about 5 mm above the 0.5 magnification isocurve 40 for a lens 10 having a maximum addition power of 3.00. Lenses 10 having a maximum addition power between 1.00 and 3.00 may include a margin between 5 mm and 9 mm. Likewise, lenses 10 having a maximum addition power below 1.00 may have a margin above 9 mm, and lenses 10 having a maximum addition power above 3.00 may have a margin of less than 5 mm.

Yet another of the inventive principles that lead to a superior distance vision area 100 relies on maintaining the peripheral regions of the distance vision area 100 free of astigmatism, to the extent possible. This allows the user to scan his or her pupils left and right within the distance vision area 100 and still find a relatively wide region of usable lens surface. In contrast, if significant amounts of astigmatism were allowed to extend into the peripheral regions of the distance vision area 100, the user would not be able to glance into the periphery of the distance vision area 100, and would instead have to turn his or her head to align the center portion of the lens 10 over the wearer's viewing target, in order to be able to look through a portion of the lens 10 that is free from astigmatism. With reference to the drawings, and particularly FIG. 1A, it can be seen that the 0.5 astigmatism isocurve is entirely below the fit point 60 on the temple side of the lens 10. As such, when a wearer scans his or her pupils to the periphery of the lens 10, he or she will find a relatively clear (free from astigmatism) field of view, without having to reorient the lens 10 itself.

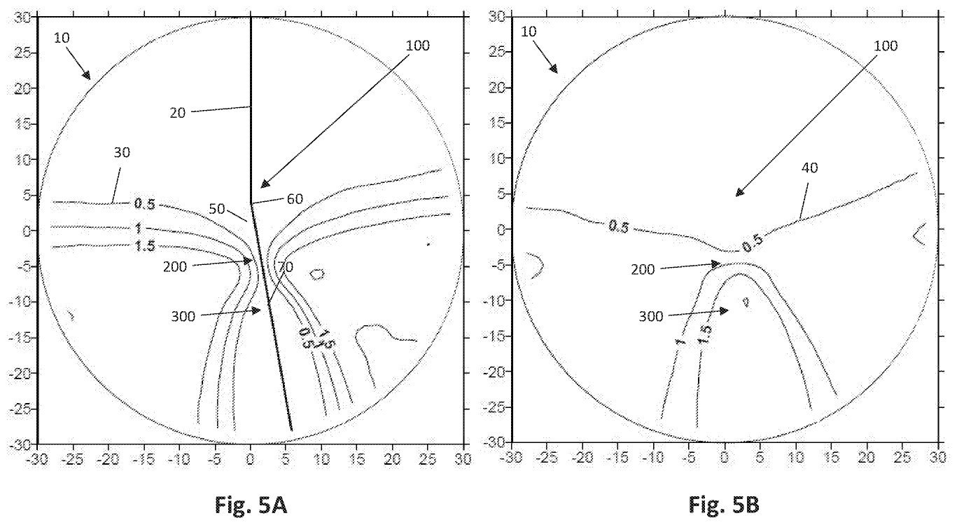

As may be understood, for lenses 10 with a relatively low maximum addition power (e.g., 1.00) the maximum level of astigmatism present in the lens 10 is also relatively low. As the maximum addition power of the lens 10 increases, the maximum level of astigmatism also increases. With respect to FIG. 9A, a lens 10 having a maximum addition power of 3.00 is depicted, and, as can be seen, several astigmatism isocurves 30 are depicted, ranging from 0.5 to 2.5. In order to maintain the astigmatism gradient throughout the lens at a relatively comfortable slope, the various astigmatism isocurves 30 should be spread across the surface of the lens 10. Accordingly, the inventors have found that for lenses 10 having a maximum addition power up to and including about 2.00, the 0.5 astigmatism isocurve 30 can be maintained at or below the level of the fit point 60, without making the astigmatism gradient of the lens 10 undesirably steep. Such an arrangement is depicted in FIG. 5A. For lenses 10 having a maximum addition power above 2.00, the inventors have determined that some amount of encroachment of astigmatism above the fit point 60 is a suitable sacrifice in order to maintain a comfortable astigmatism gradient throughout the lens. Yet, as can be seen in FIG. 9A, even for a lens 10 having a maximum add power of 3.00, the encroachment of the 0.5 astigmatism isocurve 30 into the distance vision area 100 is limited to about 1-2 mm above the fit point 60.

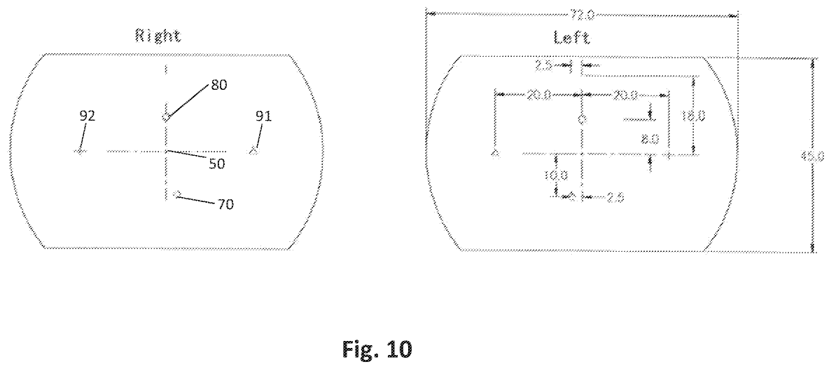

The present invention also includes features and elements which facilitate mass production of the inventive progressive lenses 10 and mass production of eyewear having the inventive progressive lenses 10. As can be seen in FIG. 10, in a preferred embodiment, the lens is circular for a portion of its perimeter, and the circular portions may have a diameter of 72 mm. The remainder of the lens is a truncated circle that is 45 mm in height along a vertical axis of the lens. As such, a corresponding lens mold consisting of such a truncated circle 72 mm in diameter by 45 mm in height may be employed to produce the inventive lens. One advantage of the truncated circle configuration is material savings in production. Additionally, the flat edges of the truncated circle facilitate proper orientation and positioning in jigs, fixtures, holders, and other apparatus during various manufacturing processes, e.g., within an edging fixture as may be used during a lens edging process.

Additionally, preferred embodiments of the inventive lens may include markings which facilitate fitment and placement of the lens within eyewear frames. Such markings may be temporary, such as a decal that can be removed after mounting and/or fitment upon a wearer, and may also be permanent, such as by being etched or engraved into an inconspicuous portion of the lens and/or a portion of the lens that will be obfuscated. In one embodiment such markings may include the product name, an indication of the lens 10 power addition (such as the full magnification power of the near vision area 300), as well as a designation of whether the lens 10 is intended for the wearer's left eye or right eye.

In yet another embodiment, additional markings may be provided to facilitate various manufacturing and quality inspection processes. By way of example, and with reference to the embodiment depicted in FIG. 10, a cross (+) is placed on the lens 10 toward the temple portion as a temple side marker 92, while a triangle is placed on the lens 10 toward the nasal portion as a nasal side mark 91. Such an arrangement facilitates quality inspections via assurance of correct positioning and orientation of the lenses 10 within eyewear frames. In a preferred embodiment, the temple side marker 92 is disposed 20 mm from the PRP 50, while the nasal side marker 91 is disposed 20 mm from the PRP 50, directly opposite the temple side marker 92 (establishing 40 mm of space therebetween). The inventors have determined that this spacing optimizes the visibility of each marking during quality inspections, but also places the markings outside of the natural vision zone, such that a wearer is not likely to be able to see the markings when wearing the lenses 10. Yet, in alternative embodiments, the temple side marker 92 and nasal side marker 91 may be spaced as little as 15 mm away from the PRP 50. The nasal side mark 91 and temple side marker 92 may also be placed on either of the convex or concave surfaces of the lens 10. For context, the center of the lens opening 1000 in the eyewear frame, the near reference point 70, and the distance reference point 80 are depicted in FIGS. 10-12, but it will be appreciated that these reference points are not ordinarily permanently placed on a commercial embodiment of a physical lens, as might be the case with the nasal 91 and temple side markers 92. The center of the lens opening 1000, near reference point 70, and distance reference point 80 have only been included in FIGS. 10-12 to facilitate disclosure and understanding of the present invention. Additionally, throughout FIGS. 10-12, relevant features have been called out with reference numerals on the right eye lens, while corresponding measurements are generally presented on the left eye lens.

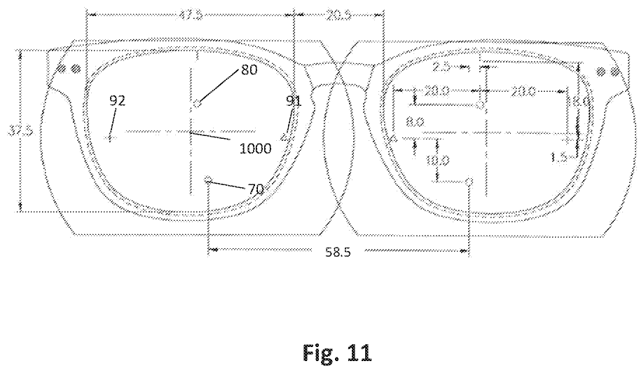

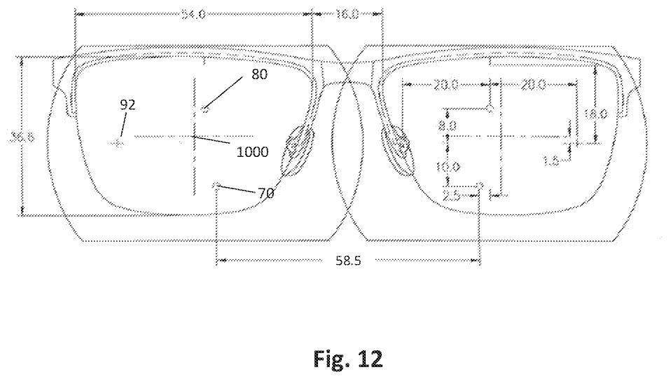

Another aspect of the present invention is directed to the fitment and orientation of the lenses 10 within the frames. Typically, progressive lenses are created and fitted to a particular wearer, but the lenses of the present invention may be suitable for mass production and sold at retail alongside more typical “reading” glasses. In a preferred embodiment, fitment within eyewear frames assumes a 58.5 mm near pupillary distance (“PD”), i.e., the approximate distance between pupils when a wearer focuses on the near distance. Given the 58.5 mm PD, a 72 mm by 45 mm lens blank (as is provided in preferred embodiments) will fit a wide variety of eyewear frames, such as those with a maximum lens height of up to 45 mm, but preferably not larger than 42 mm. For eyewear frames with adjustable nose pads, as is exemplified in FIG. 12, the center of the lens (i.e., the PRP 50) may coincide with the center of the lens opening on the eyewear frame. For non-adjustable nose pads, as is exemplified in FIG. 11, the fit height may be optimized with respect to the distance between lenses (“DBL”) or bridge size. By way of example, for eyewear frames with a DBL of 16 mm, the fit height may coincide with the center of the lens opening. Alternative DBL measurements may call for raising or lowering the fit height of the lens within the lens opening as is necessary. The inventors have also determined that for the disclosed corridor length of 14 mm, a most preferred minimum lens height should be observed as 35 mm in order to provide adequate room for the near vision area 300. Although in alternative embodiments, a minimum lens height of as little as 34 mm may also be suitable. While the embodiments depicted in FIGS. 11 and 12 may disclose certain preferred dimensions for various embodiments, the precise dimensions may vary without departing from the spirit and scope of the invention.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A progressive addition lens comprising:
a fit point located 4 mm above a prism reference point of the lens;
a reading reference point located 10 mm below said prism reference point and 2.5 mm nasal thereof; and
a distance vision zone extending upward from said fit point having zero addition power.

2. The progressive addition lens as recited in claim 1 wherein the lens has a maximum addition power of at least 0.25 at said reading reference point; wherein said fit point is at least 9 mm above a 0.5 magnification isocurve of the lens.

3. The progressive addition lens as recited in claim 1 wherein the lens has a maximum addition power of up to, and including, 3.00 at said reading reference point; wherein said fit point is at least 5 mm above a 0.5 magnification isocurve of the lens.

4. The progressive addition lens as recited in claim 1 wherein said fit point is between 5 mm and 9 mm above a 0.5 magnification isocurve of the lens.

5. The progressive addition lens as recited in claim 1 wherein the lens has a maximum addition power of at least 1.00 at said reading reference point; wherein a 0.5D astigmatism isocurve does not extend above the fit point on a temple side of said lens.

6. The progressive addition lens as recited in claim 1 wherein the lens has a maximum addition power up to, and including, 2.00 at said reading reference point; wherein a 0.5D astigmatism isocurve does not extend above the fit point on a temple side of said lens.

7. The progressive addition lens as recited in claim 1 wherein the progressive addition lens comprises a truncated circle configuration having a lens height of not more than 45.00 mm, and a circular diameter of not more than 72.0 mm.

8. The progressive addition lens as recited in claim 1 wherein the progressive addition lens is fit within an eyewear frame having a lens height of not more than 42.0 mm.

9. The progressive addition lens as recited in claim 1 wherein the progressive addition lens is fit within an eyewear frame having a lens height of not less than 34.0 mm.

10. The progressive addition lens as recited in claim 1 further comprising a nasal side marker and a temple side marker disposed on said lens.

11. The progressive addition lens as recited in claim 9 wherein said nasal side marker and said temple side marker comprise differing shapes.

12. The progressive addition lens as recited in claim 9 wherein each of said nasal side marker and said temple side marker are disposed at least 15.0 mm away from said prism reference point of said lens.

13. Eyewear having progressive addition lenses, the eyewear having a lens height of not more than 42.0 mm, each progressive addition lens comprising:
a distance vision area beginning at approximately four millimeters above a prism reference point of the lens and extending toward the top of the lens;
a fit point coinciding with said beginning of said distance vision area;
an intermediate vision area traversing an intermediate region of approximately fourteen millimeters in length; and
a near vision area beginning at approximately ten millimeters below the prism reference point and extending toward the bottom of the lens.

14. The eyewear as recited in claim 13 wherein the lens has a maximum addition power of at least 1.00 at said near vision area; wherein said fit point is at least 9.0 mm above a 0.5 magnification isocurve of the lens.

15. The eyewear as recited in claim 13 wherein the lens has a maximum addition power of up to, and including, 3.00 at said near vision area; wherein said fit point is at least 5.0 mm above a 0.5 magnification isocurve of the lens.

16. The eyewear as recited in claim 13 wherein said fit point is between 5.0 mm and 9.0 mm above a 0.5 magnification isocurve of the lens.

17. The eyewear as recited in claim 13 wherein the lens has a maximum addition power of at least 1.00 at said near vision area; wherein a 0.5D astigmatism isocurve does not extend above the fit point on a temple side of said lens.

18. The eyewear as recited in claim 13 wherein the lens has a maximum addition power up to, and including, 2.00 at said near vision area; wherein a 0.5D astigmatism isocurve does not extend above the fit point on a temple side of said lens.

19. The eyewear as recited in claim 13 further comprising a nasal side marker and a temple side marker disposed on said lens.

20. The eyewear as recited in claim 19 wherein said nasal side marker and said temple side marker comprise differing shapes.
